(19) United States
(12) Patent Application Publication
(10) Pub. No.: US 2023/0067916 A1
(43) Pub. Date: Mar. 2, 2023

(54) METHODS AND SYSTEMS FOR CONSTRUCTION IMPLEMENT MANAGEMENT

(71) Applicant: Zachary Liollio, Charleston, SC (US)

(72) Inventor: Zachary Liollio, Charleston, SC (US)

(21) Appl. No.: 17/411,927

(22) Filed: Aug. 25, 2021

(51) Int. Cl. G05D 1/02; G06F 3/0482; G05D 1/00

(52) U.S. Cl. CPC G05D 1/0212; G06F 3/0482; G05D 1/0016; G05D 2201/0201; G05D 2201/0202; G05D 2201/0208

(57) ABSTRACT

Methods, systems, and apparatus are described herein for providing operational efficiency at a construction site through a connected system of on-board mobile computers.

### BACKGROUND

Modern roadway construction sites are busy and dangerous places. Presently, large teams of construction works must manually operate a wide array of complex machinery located at the site resulting in a crowded, dangerous workplace. There is no centralized control system to coordinate and automate many of the construction implements and specific construction tasks required to complete a construction project. A new method of construction site management is needed.

### SUMMARY

It is to be understood that both the following general description and the following detailed description is merely an example and is explanatory only and is not restrictive. Methods, systems, and apparatuses for construction site management are provided. An operator in a supervisor vehicle to can set input parameters and execute a programmed construction/maintenance activity. Unlike other similar systems, this allows for inputs such as design drawings, rate, thickness of material, and dimensions and can analyze existing surfaces to detect obstacles. The invention also allows for human override and can take over the most dangerous highway tasks. It is adaptable to different modes of transportation.

### BRIEF DESCRIPTION OF THE DRAWINGS

The accompanying drawings, which are incorporated in and constitute a part of this specification, illustrate embodiments and together with the description, serve to explain the principles:

FIG. 1 is a block diagram of an example system;

FIG. 2 is a block diagram of an example system;

FIG. 3 is an example system;

FIGS. 4A-4B show an example operating environment;

FIG. 5 is an example method; and

FIG. 6 is a block diagram of an example system.

### DETAILED DESCRIPTION

Before the present techniques are disclosed and described, it is to be understood that this disclosure is not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” or “example” means “an example of” and is not intended to convey an indication of a preferred or ideal embodiment. “Such as” is not used in a restrictive sense, but for explanatory purposes.

Disclosed are components that can be used to perform the disclosed construction implement management techniques. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present systems and methods may be understood more readily by reference to the following detailed description of preferred embodiments and the examples included therein and to the Figures and their previous and following description.

As will be appreciated by one skilled in the art, the construction implement management techniques may take the form of an entirely hardware embodiment, an entirely software embodiment, or an embodiment combining software and hardware aspects. Furthermore, the construction implement management techniques may take the form of a computer program product on a computer-readable storage medium having computer-readable program instructions (e.g., computer software) embodied in the storage medium. More particularly, the present construction implement management techniques may take the form of web-implemented computer software. Any suitable computer-readable storage medium may be utilized including hard disks, CD-ROMs, optical storage devices, or magnetic storage devices.

Embodiments are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

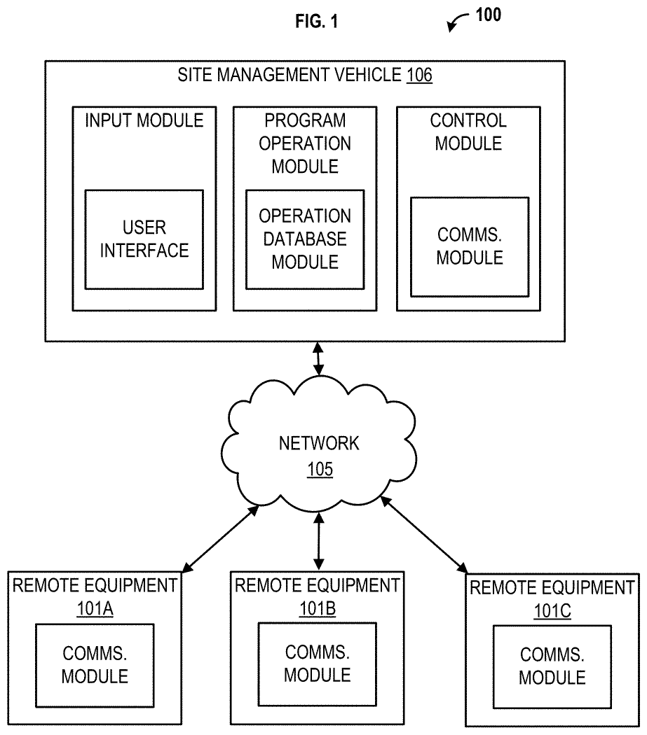

FIG. 1 shows an example system 100 in which the present methods and systems may operate. One skilled in the art will appreciate that provided herein is a functional description and that the respective functions can be performed by software, hardware, or a combination of software and hardware. The system 100 may facilitate construction activity management. The system may comprise, for example, a site management vehicle 106 and one or more pieces of remote equipment 101A-C. The one or more pieces of remote equipment may be modular and may not be integral to one or more vehicles associated with the one or more pieces of remote equipment 101A-C. For example, modular hardware associated with the one or more pieces of remote equipment may be removably and communicatively coupled to the one or more vehicles. The site management vehicle 106 and the one or more pieces of remote equipment 101A-C may be configured to communicate via a network 105.

The system 100 may comprise a plurality of vehicles including, but not limited to, for example a site management vehicle 106 and one or more other vehicles or pieces of equipment 101A-C. The network 105 may comprise any telecommunications network such as the Internet or a local area network. Other forms of communications can be used such as wired or wireless telecommunication channels, for example. The network 105 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof.

The site management vehicle 106 may comprise an input module. The input module may an interface configured to receive one or more user inputs. The one or more user inputs may be received via one or more selectable options. For example, the user interface may comprise a touch screen, mouse and keyboard interface, or any other suitable interface. The one or more user inputs may be associated with one or more programmed construction activities. The one or more user inputs may comprise commands. For example, A designer/operator could also input commands individually in the form of (station/offset to station/offset=executable command). Ex. (Station 300+00 Right Offset 45 ft to Station 301+00 Right Offset 45 ft=Mill Continuous Rumble Strip.exe). More complex designs, such as lines that follow curves/arcs, could be their own individual executable command for the remote implement (ex. Station 400+00 Right Offset 60 ft=Paint 120 ft Pedestrian Crosswalk.exe).

The one or more user inputs may comprise data files such as project designs, project drawings, project descriptions, design drawings, design descriptions, CAD files, combinations thereof, and the like. For example the input module may be configured to receive one or more design drawings. The input module may be configured to, for example, based on a design drawing of the one or more design drawings, generate and/or otherwise determine one or more command codes. For example, the design drawing may comprise one or more survey stations, project parameters, task parameters, markers, notifications, or other information configured to convey information to a program module. The one or more survey stations may be configured to covey information related to tasks associated with locations in a project site. The one or more inputs can include standard specifications which could determine upper/lower tolerances (spacing/distance in relation to other design elements, etc.), utility survey data to show were utilities hazards exist such as buried cables, weather data to determine upper/lower construction tolerances (ex. too cold to install asphalt, so the remote implement stops). For example, the utility survey data may be configured to indicate clash detection data. For example, a marker in the design file may indicate the location for a buried utility. For example, a pipe may have been installed 70-years-ago under a road and abandoned. Based on the clash detection data, a remote implement may warn the operator/site manager if the a task or project will interfere with the pipe. For example, the clash detection data may comprise elevation data, distance to surface data (e.g., how far below a working surface of the project is the utility buried), location data (e.g., GPS coordinates), dimensional data (e.g., a pipe radius, diameter, length, etc.), combinations thereof, and the like.

The one or more inputs may comprise dynamic information such changes to a project site caused, for example, by environmental factors or mechanical factors (e.g., an equipment malfunction). For example, the one or more inputs may comprise one or more “work orders.” The one or more works orders may comprise, for example an indication that a road surface has collapsed or a pothole has formed (e.g., due to erosion). Similarly, out of specification parameters may be detected (for example if a jackhammer malfunctions or is used improperly and a hole is made in a road surface). For example, emergency reports can also be input files. For example, the one or more works orders may be received from outside the project. For example, if a pothole forms in the project area a device (e.g., mounted on a smart/self-driving vehicle) may detect the pothole and report it. For example, the smart vehicle may send a message to a responsible agency (e.g., the site management vehicle) and accordingly the site manager in the work zone near the pothole can be notified. In an embodiment, the program operation module may task pieces of equipment to fill the pothole at the reported location with one or more of the remote implements. The same can be applied for litter and large pieces of debris.

The program operation module may be configured to determine, based on the one or more user inputs, the one or more programmed construction activities. For example, the one or more programmed construction activities may comprise at least one of: depositing one or more construction materials, moving or otherwise manipulating a construction material, moving or otherwise manipulating a piece of equipment, controlling one or more subsystems, or activating or deactivating a setting. The aforementioned one or more programmed construction activities are merely exemplary and explanatory and are not intended to be limiting. A person skilled in the art will appreciate that the one or more programmed construction activities can comprise any activity, action, operations, etc. which may take place at a construction site. The one or more subsystems may comprise at least one of a sensor array subsystem, a mechanical subsystem, a secondary terminal subsystem, or a local wireless network. For example, a survey station may be placed along a route. The survey station may comprise, for example, a beacon or other piece of communications equipment. For example, as one or more construction implements move along the route, a path associated with the one or more construction implements may be determined. For example, a pavement marking remote implement may be caused, as the design file is processed, to deposit paint were the design file depicts a painted line. For example, the program operation module may scan the design file a location and determine a start/stop command (or any other command) for the one or more construction implements. The program module may send a message to the one or more construction implements. The message may be configured to cause the one or more construction implements to execute the command.

The program operation module may comprise an operation database module. The operation database module may comprise a database configured to store one or more construction activities, one or more construction tasks associated with each construction activity of the one or more construction activities, one or more construction task parameters associated with each construction task, one or more construction implements associated with each construction task of the one or more construction tasks, one or more command codes associated with each construction task of the one or more construction tasks, combinations thereof, and the like. For example, the operation database module may store associations between the one or more construction activities, the one or more construction tasks, the one or more construction implements, and the one or more construction command codes. For example, a first construction activity of the one or more construction activities may comprise road surface marking. For example, a second construction activity may comprise road surface smoothing. The road surface marking construction activity may be associated with one or more constructions tasks. For example, a first construction task or the road surface marking construction activity may comprise spraying a high-pressure water jet on the area to be marked so as to clean the road surface. For example, a second construction task of the road surface marking construction activity may comprise depositing a paint stripe comprising a given amount of paint for a given distance or length of time, or other construction task parameter. Each construction task may be associated with a command code. For example, the construction task of spraying the water jet at the surface may be associated with a first command code while the construction task of depositing the layer of paint may be associated with as second command code. The first command code may be associated with one or more construction task parameters such as how much water to dispense, a pressure rating, a timing parameter, a valve diameter (e.g., the diameter of the “nozzle”), combinations thereof, and the like. Similarly, the second command code may be associated with one or more construction task parameters such as a type or color of paint, an amount of paint, a timing parameter, a width parameter (e.g., how wide a strip of paint should be), combinations thereof, and the like.

The site management vehicle 106 may comprise a control module. The control module may be configured to facilitate, via a communications module, the control of the one or more remote equipment 101A-C. For example, based on a selection of the one or more programmed construction activities, the control module may select and/or designate remote equipment 101A to execute a first programmed construction activity of the one or more programmed construction activities. Likewise, based on a selection of the one or more programmed construction activities, the control module may select and/or designate remote equipment 101B to execute a second programmed construction activity of the one or more programmed construction activities. Similarly, based on a selection of the one or more programmed construction activities, the control module may select and/or designate remote equipment 101C to execute a third programmed construction activity of the one or more programmed construction activities. The control module may comprise a communications module configured to send and receive data. For example, the control module may be configured to send one or more command codes to the one or more pieces of remote equipment 101A-C.

Each piece of remote equipment of the one or more pieces of remote equipment 101A-C may comprise a communications module. The communications module may be configured to send and receive data via the network 105. For example, each communications module may be configured to receive a command code from the site management vehicle 106.

For example, the communications module in remote equipment 101A may receive the first command code to spray the high pressure water jet while the communicates module in remote equipment 101B may be receive the second command code to dispense the paint. Based on receiving a command code, the remote equipment may execute the construction task. For example, the remote equipment 101A may spray the high powered water jet and remote equipment 101B may dispense the paint. The aforementioned examples are merely explanatory and exemplary and a person skilled in the art will appreciate that a command code may be associated with any construction task.

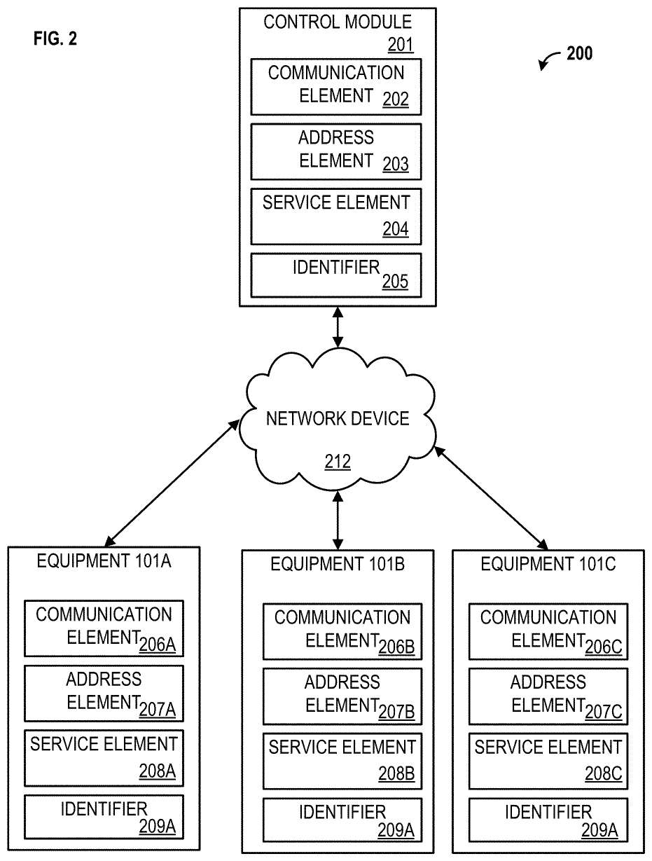

FIG. 2 shows a system 200 for construction management. Those skilled in the art will appreciate that digital equipment and/or analog equipment may be employed. One skilled in the art will appreciate that provided herein is a functional description and that the respective functions may be performed by software, hardware, or a combination of software and hardware.

The system 200 may comprise a control module 201, and a plurality of user equipment 101A-C. The control module 201 and the plurality of equipment 101A-C may communicate via a network device 212. The network device 212 may be configured to facilitate communications via the network 105. The network device 212 may be configured as a local area network (LAN). The network device 212 may be a dual band wireless communication device. The network device 212 may be a gateway device for communicating with another network, such as a communication network provided by an Internet Service Provider. The network device 212 may be configured with a first service set identifier (SSID) (e.g., associated with a user network or private network) to function as a local network for a particular user or users. The network device 212 may be configured with a second service set identifier (SSID) (e.g., associated with a public/community network or a hidden network) to function as a secondary network or redundant network for connected communication devices. The network device 212 may be configured to allow one or more wireless devices to connect to a wired and/or wireless network using Wi-Fi, Bluetooth, ZigBee, Z-Wave, or any desired method or standard. The network device 212 may have a communication element 202, an address element 203, a service element 204, an identifier 2015. The communication elements 202 may comprise one or more wireless transceivers configured to transmit and receive wireless communications via a wireless communication network (e.g., the network 105). The communication element 202 may be configured to communicate via a specific network protocol for example, a Wi-Fi protocol and/or a Wireless Personal Area Network (WPAN) protocol. The WPAN may operate using a low-energy network protocol, such as a ZigBee network protocol; a Bluetooth™ network protocol, a Z-Wave network protocol, a combination thereof, and/or the like.

The control module may comprise a communication element 202. The communication element 202 may be configured to communicate with communication element 202 of the network device 212. The communication elements 202 may be configured to communicate via a specific network protocol. The communication element 202 may be a wireless transceiver configured to communicate via a Wi-Fi network.

The control module 201 may comprise an address element 203. The address element 203 may be, for example, an internet protocol address, a network address, a media access control (“MAC”) address, an Internet address, or the like. The address element 203 may be relied upon to establish a communication session between the control 201 and the network device 212 or other devices and/or networks (e.g., the plurality of equipment 101A-C). The address element 203 may be used as an identifier or locator of the control module 201. The address element 203 may be persistent for a particular network.

The control module may comprise a service element 204. The service element 204 may comprise an identification of a service provider or other organization (e.g., a company) associated with the control module 201. The class of the control module 201 may be related to a type of device, capability of device, type of service being provided, and/or a level of service. The level of service may be, for example, business class, service tier, service package a combination thereof; and/or the like. The service element 204 may comprise information relating to or provided by a communication service provider (e.g., Internet service provider) that is providing or enabling data flow such as communication services to the control module 201. The service element 204 may comprise information relating to a preferred service provider for one or more particular services relating to the computing device 210. The address element 203 may be used to identify or retrieve data from/via the service element 204, or vice versa. One or more of the address element 203 or the service element 204 may be stored remotely from the control module 201. Other information may be represented by the service element 204.

The control module may comprise an identifier 205. The identifier 205 may be or relate to, for example, an Internet Protocol (IP) Address IPV4/IPV6 or a media access control address (MAC address) or the like. The identifier 205 may be a unique identifier for facilitating wired and/or wireless communications with the network device 212. The identifier 205 may be associated with a physical location of the network device 212.

Each of the equipment 101A-C may also comprise may comprise a respective communication element 206A-C, an address element 207A-C, a service element 208A-C, and an identifier 209A-C.

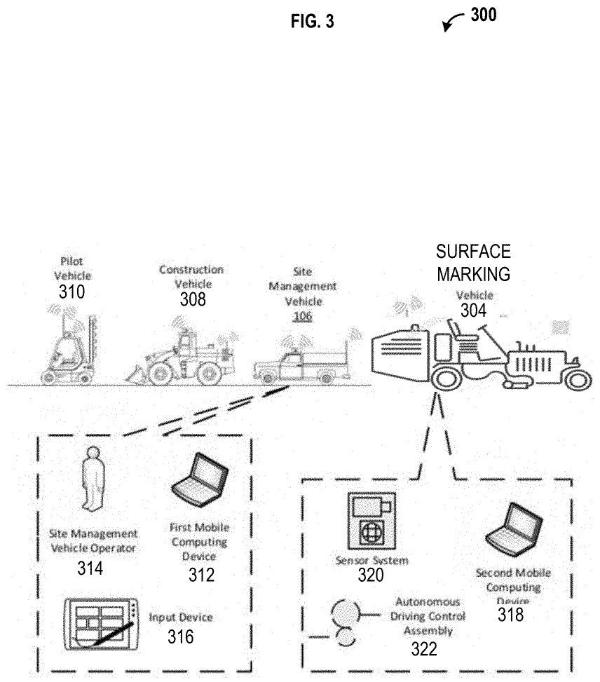

FIG. 3 shows an example system 300. The system may comprise a plurality of roadway construction vehicles and operative equipment. The plurality of roadway construction vehicles is not limited to vehicles depicted in FIG. 3, and additional example embodiments include typical roadway construction vehicles such as articulated trucks, asphalt pavers, compressors, backhoe loaders, cold planers, compact track and multiterrain loaders, crushers, dozers, feller bunchers, forest machines, remixing transfer vehicles, skidders, skid steer loaders, screeners, road wideners, track excavators, wheel dozers, wheel excavators, wheel loaders, wheel tractor scrapers, dump trucks, and hauling vehicles. For example, the plurality of road way construction vehicles may comprise, for example, pilot vehicle 310, construction vehicle 308, the site management vehicle 106, surface marking vehicle 304. In the example shown in the figure, the vehicle surface marking vehicle 304 is at the rear of the roadway construction project. The surface marking vehicle 304 may be configured with a communications assembly that allows communication to the site management vehicle 106, as well as the entire plurality of roadway construction vehicles. The surface marking vehicle 304 may be configured with autonomous driving technology. In the example embodiment the surface marking vehicle 304 may be configured with a mobile computing device. The mobile computing device maybe coupled to the surface marking vehicle 304 so that the mobile computing device is integrated into the road surface marking vehicle's power supply. Additional embodiments allow the mobile computing device to be plug-and-play and capable of switching from any one of the plurality of roadway construction vehicles.

In the example embodiment the sensor system 320 contains an image processing unit which may be configured to identify road surface marking guidelines or other markings on the surface of a roadway. Such markings may indicate, for example a travel path, a travel path side boundary, a center line and the like, and measures the length of the lines in relation to the vehicle. In particular, through the sensing of the yellow guidelines on the travel path, the spatial relationship between the vehicle and the travel path is calculated, i.e. the distance of the vehicle from the yellow guideline.

In the example embodiment the sensor system 320 may further contains an ultrasonic sensor, a laser radar, and receivers for detecting objects and/or obstacles located on the travel path in front of the vehicle and to the side of the vehicle, as, for example, a vehicle traveling in front, a protective barrier, and the like, and for transmitting the corresponding information to the mobile computing device of the vehicle. Additional sensors in the sensor system 320 of the present embodiment include wheel speed sensors which may be located on the left and right rear wheels of the vehicle, a mobile computing device, in the example of FIG. 3, the second mobile computing device 318 is equipped with a processing unit that receives and processes the output signals of the two wheel speed sensors, and a global positioning unit for calculating the location of the vehicle in global coordinates. The processing unit and the calculation unit are executed in the mobile computing device onboard the road surface marking vehicle and the site management vehicle. The wheel speed sensors detect the rotation of the road surface marking vehicle's rear wheels and generate several thousand pulses per revolution for each wheel. When a difference is found in the number of pulses generated for the individual wheels, this means that there is a difference in the distance covered by the corresponding wheels, and this difference in the distance covered forms the basis for determining the curvature of the section of travel path being traveled by the vehicle. In addition, the distance covered by both wheels indicates the distance traveled by the road surface marking vehicle. The path of the road surface marking vehicle 304 can thus be calculated on the basis of the sequences of data provided by the wheel speed sensors and transmitted to the site management vehicle 106 wherein the site management vehicle operator 314 may control the parameters in which the road surface marking vehicle 304 may operate under. In particular, information relating to the location and position of the vehicle at a specific point in time, i.e. information regarding the vehicle's location and direction of travel in an X-Y coordinate system, can be derived and transmitted to the site management vehicle 106.

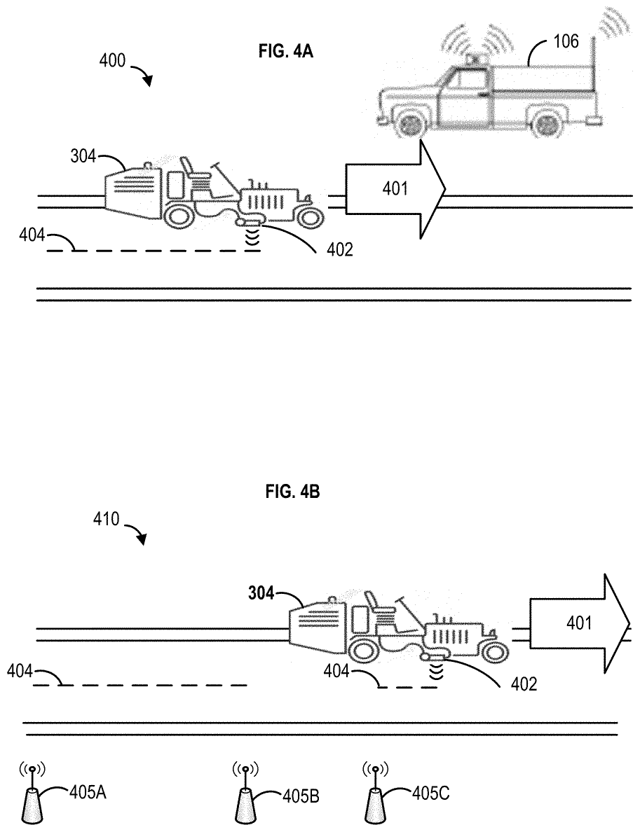

FIG. 4A shows an example system 400. FIG. 4B shows an example system 410. While systems 400 and 410 are shown in separate figures with different components, a person skilled in the art will appreciate that the methods and techniques discloses herein may be carried out on either or both of the systems 400 and 410, combinations thereof, and the like. Further, while both systems are shown comprising surface marking vehicle 304, a person skilled in the art will appreciate that one or more of any construction implements or maintenance equipment or the like may be included.

FIG. 4A shows the surface marking vehicle 304 proceeding along a route 401. The route 401 may be associated with a project site. For example, the route 401 may comprise a path the surface marking vehicle 304 takes along a surface in order to mark the surface. For example, the surface marking vehicle 304 may comprise a surface marking module configured to deposit one or more materials to generate one or more surface marks 404. The system 400 may comprise the site management vehicle 106. The site management vehicle 106 may comprise a control module. The control module may be configured to facilitate, via a communications module, the control of the one or more remote equipment 101A-C. For example, based on a selection of the one or more programmed construction activities, the control module may select and/or designate the surface marking vehicle (e.g., and/or a surface marking module thereon) to execute a first programmed construction activity of the one or more programmed construction activities. The control module may comprise a communications module configured to send and receive data. For example, the control module may be configured to send one or more command codes to the surface marking vehicle 304. In FIG. 4A, the control module on the site management vehicle 106 may send

FIG. 4B shows system 400 wherein the surface marking vehicle 304 is proceeding along a route 411. The route 411 may the same route a different route than route 401. The system 400 may comprise one or more survey stations 405A-C. The one or more survey stations 405A-C may be configured to send and receive data. For example, the one or more survey stations 405A-C may be configured to send one or more commands to a construction implement. For example, the one or more survey stations 405A-C may be configured to send, to the surface marking vehicle (and/or a surface marking module thereon), one or more commands associated with one or more construction tasks. For example, the one or more survey stations 405A-C may be configured to send, to the surface marking vehicle (and/or a surface marking module thereon), one or more surface marking commands associated with one or more surface marking tasks. For example, the one or more survey stations 405A-C may be configured to send one or more start/stop commands to the surface marking module. For example, a first survey station 405A of the one or more survey stations 405A-C may be at a first location along the route 401, a second survey station 405B of the one or more survey stations 405A-C may be at second location along the route 401, and a third survey station 405C may be at a third location along the route 401. A first proximity between the surface marking vehicle 304 and the first survey station 405A may be determined. Based on the first proximity, a first command may be sent from the first survey station 405A to the surface marking module. For example, the first command may be configured to cause the surface marking module to dispense one or more surface marking materials. Similarly, a second proximity between the surface marking vehicle 304 and the second survey station 405B may be determined. Based on the second proximity, a second command may be sent from the second survey station 405B to the surface marking module. For example, the second command may be configured to cause the surface marking module to cease dispensing one or more surface marking materials. Likewise, a third proximity between the surface marking vehicle 304 and the third survey station 405C may be determined. Based on the third proximity, a third command may be sent from the third survey station 405C to the surface marking module. For example, the third command may be configured to cause the surface marking module to resume dispensing one or more surface marking materials. The aforementioned surface marking examples is merely exemplary and explanatory and a person skilled in the art will appreciate that any command may be sent or received by any construction implement. For example, the present disclosure contemplates road construction and other engineering and building such as erecting buildings, bridges, facilities for rail travel, water travel, air travel etc., combinations thereof, and the like.

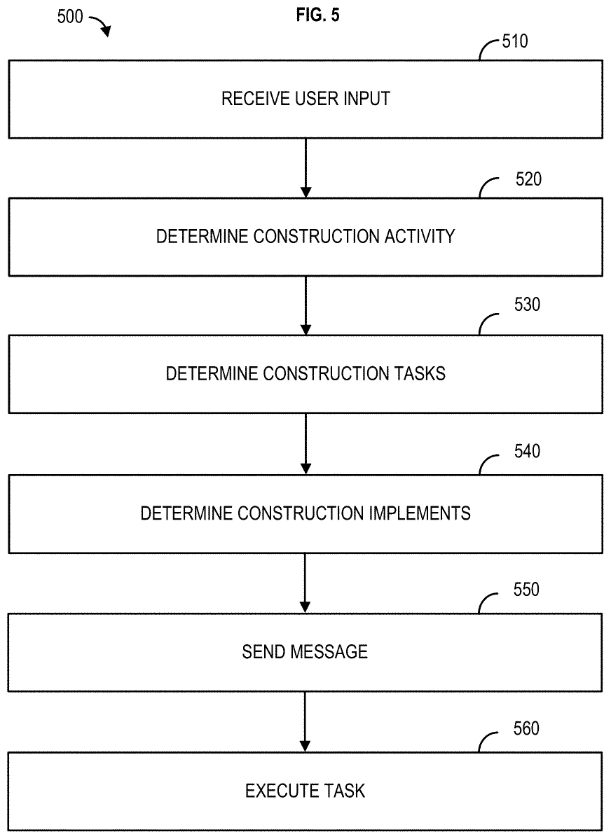

FIG. 5 shows an example method 500, executing on one or more of the devices of FIG. 1. At step 510, a computing device may receive one or more user inputs. For example, the computing device may be in communicate with the input device 116. The input device 116 may receive via a touchscreen or other suitable interface, the one or more user inputs. For example, the user device 116 may display a menu comprising one or more selectable options. The selectable options may be associated with, or indicate, one or more construction activities. The one or more user inputs may comprise digital files such as design drawings, project blueprints, CAD files, combinations thereof, and the like.

At step 520, one or more construction activities may be determined. The one or more construction activities may be determined based on the one or more user inputs. The one or more construction activities may comprise roadway construction activities such as road surface marking or paving a road. Each construction activity of the one or more construction activities may be associated with one or more construction tasks.

At step 530, one or more construction tasks may be determined. The one or more construction tasks may be determined based on the one or more construction activities. The one or more construction tasks may comprise actions or subtasks of the construction activity. For example, if the construction activity is painting the lines on a highway, the one or more construction tasks may comprise applying one or more surface marking materials such as paint, stones, thermoplastic, polymer tape, epoxy, glass beads, combinations thereof, and the like. For example, if the construction activity is paving a road, the one or more construction tasks may comprise demolishing the present road, grading and sloping a surface, preparing a sub base, proof rolling, and undercutting (e.g., sub base repair), applying binders and surface coursing, laying an asphalt surface, installing butt joints and transitions, and executing a final roll.

At step 540, one or more construction implements may be determined. The one or more construction implements may be determined based on the one or more construction tasks. For example, the computing device may query a database for information associate with the one or more construction tasks. For example, a painting implement may be associated with a road marking construction task and a steamroller may be associated with surface smoothing construction task.

At step 550, one message may be sent. The message may be sent, for example, from the computing device to a communications module on a construction implement of the one or more construction implements. The message may comprise a data packet. The message may be sent, for example, by way of a local area network, a Bluetooth network, a low power local network. combinations thereof and the like. For example, the painting implement may comprise a communications module configured to receive the message. The message may comprise a command code. The command code may be associated with a construction task. For example, the command code may comprise a string of characters or arrangement of bits. The command code may cause the construction implement to execute the construction task. The command code may comprise parameters associated with the construction tasks.

At step 560, the construction implement may be caused to execute the construction task. For example, the command code may cause the painting implement to dispense a quantity of paint for a period of time or for a certain distance. For example, the command code may cause the painting implement to spray, drip, or otherwise place upon a road surface, a paint, a thermoplastic, a tape, combinations thereof and the like. For example the command code may cause the steamroller to move along a path at a certain speed and/or for a certain distance.

The method may further comprise receiving a second one or more user inputs. The second one or more user inputs may cause the construction implement to cease executing the construction task.

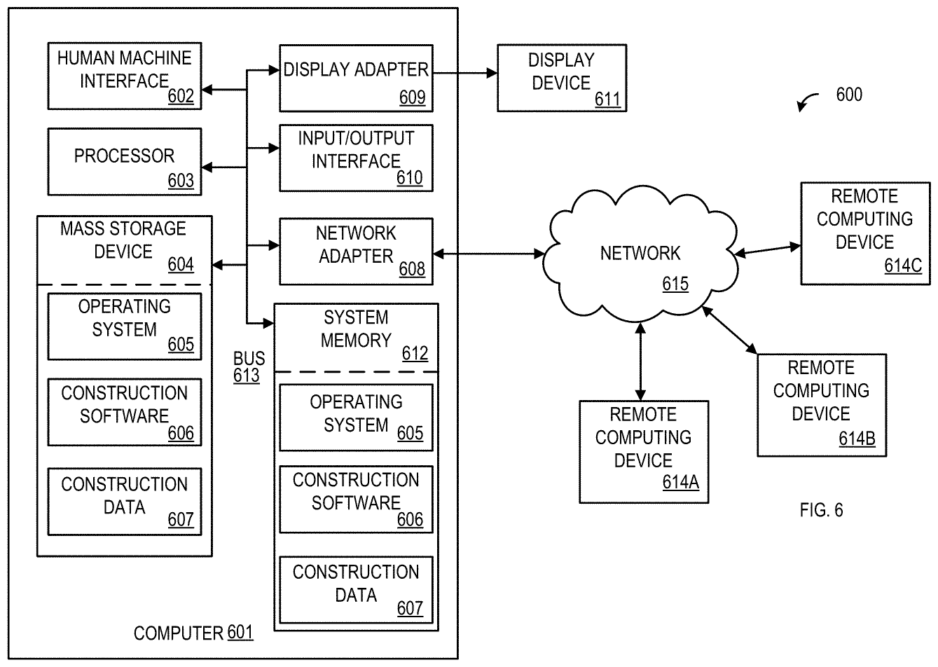

The above described disclosure may be implemented on a computer 601 as illustrated in FIG. 6 and described below. By way of example, game server 104 of FIG. 1 can be a computer as illustrated in FIG. 6. Similarly, user device 102 may be a computer as illustrated in FIG. 6. Likewise, the game server 104 or the user device 102 may be a remote computing device (e.g., remote computing devices 614A, 614B, or 614C) of FIG. 6. FIG. 6 is a block diagram illustrating an example operating environment for performing the disclosed methods. This example operating environment is only an example of an operating environment and is not intended to suggest any limitation as to the scope of use or functionality of operating environment architecture. Neither should the operating environment be interpreted as having any dependency or requirement relating to any one or combination of components illustrated in the example operating environment.

The present disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Examples comprise set top boxes, programmable consumer electronics, network PCs, minicomputers, mainframe computers, distributed computing environments that comprise any of the above systems or devices, and the like.

The processing of the disclosed can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, construction software 606, construction data 607, a network adapter 608, the system memory 612, an Input/Output Interface 610, a display adapter 609, a display device 611, and a human machine interface 602, can be contained within one or more remote computing devices 614A, 614B, 614C at physically separate locations, connected through buses of this form, in effect implementing a fully distributed system.

The computer 601 typically comprises a variety of computer readable media. Example readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the construction data 607 and/or program modules such as the operating system 605 and the construction software 606 that are immediately accessible to and/or are presently operated on by the one or more processors 603.

The computer 601 can also comprise other removable/non-removable, volatile/non-volatile computer storage media. By way of example, FIG. 6 illustrates the mass storage device 604 which can facilitate non-volatile storage of computer code, computer readable instructions, data structures, program modules, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, the operating system 605 and the construction software 606. Each of the operating system 605 and the construction software 606 (or some combination thereof) can comprise elements of the programming and the construction software 606. The construction data 607 can also be stored on the mass storage device 604. The construction data 607 can be stored in any of one or more databases known in the art. Examples of such databases comprise, DB2®, Microsoft® Access, Microsoft® SQL Server, Oracle®, mySQL, PostgreSQL, Mongo, Cassandra, and the like. The databases can be centralized or distributed across multiple systems.

The user or device can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

The display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), an augmented reality (AR) display, a virtual reality (VR) display, a projector, combinations thereof, and the like. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614A, 614B, 614C. By way of example, a remote computing device can be a gaming system, personal computer, portable computer, smartphone, a server, a router, a network computer, a peer device or other common network node, and so on. Logical connections between the computer 601 and a remote computing device 614A, 614B, 614C can be made via a network 616, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 401, and are executed by the one or more processors 403 of the computer. An implementation of the selective computing task software 406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Example computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The disclosure can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the disclosure has been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as an example only, with a true scope and spirit being indicated by the following claims.

What is claimed is:

1. A method comprising:
receiving, by a computing device, one or more user inputs;
determining, based on the one or more user inputs, one or more construction activities;
determining, based on the one or more construction activities, one or more construction tasks associated with at least one construction activity of the one or more construction activities;
determining, based on the one or more construction tasks, one or more construction implements;
sending to a construction implement of the one or more constructions implements, a message; and
causing, based on the message, the construction implement to execute the construction task.

2. The method of claim 1, wherein the one or more programmed construction activities comprises at least one of: painting highway lines, laying asphalt, laying pavement, or grooving pavement rumble strips, raised pavement markers, shoulder widening, herbicide, grass seeding, guard rail. Operations such as: reclamation of existing asphalt, cold planing (milling), grading/scraping, ditching, tilling, mowing, grubbing/clearing.

3. The method of claim 1, wherein the one or more construction implements comprise at least one of: earth moving equipment, materials moving equipment, materials dispensing equipment, demolitions equipment, digging equipment, excavating equipment, combinations thereof, and the like.

4. The method of claim 1, wherein determining the one or more construction tasks comprises:
determining an identifier associated with the construction activity; and
querying a database wherein the query comprises the identifier associated with the construction activity.

5. The method of claim 1, wherein determining the one or more construction implements comprises:
determining an identifier associated with the construction task; and
querying a database wherein the query comprises the identifier associated with the construction task; and
determining, based on the query, an association between the identifier associated with the construction task and an identifier associate with at least one construction implement of the one or more construction implements.

6. The method of claim 1, wherein sending the message comprises:
determining one or more command codes associated with at least one construction task of the one or more construction tasks; and
sending at least one command code of the one or more command codes via a local, low power communications protocol, to the construction implement.

7. The method of claim 1, further comprising receiving, by the computing device, a second user input wherein the second user input is configured to at least one of:
cause the construction implement to cease to execute the construction task or change a parameter of the construction task.

8. An apparatus, comprising:
one or more processors; and
memory storing processor executable instructions that, when executed by the one or more processors, cause the apparatus to:
receive, by the apparatus, one or more user inputs;
determine, based on the one or more user inputs, one or more construction activities;
determine, based on the one or more construction activities, one or more construction tasks;
determine, based on the one or more construction tasks, one or more construction implements;
send to at least one construction implement of the one or more constructions implements, a message; and
cause, based on the message, the construction implement to execute the construction task.

9. The apparatus of claim 7, wherein the one or more programmed construction activities comprises at least one of: painting highway lines, laying asphalt, laying pavement, or grooving pavement rumble strips, raised pavement markers, shoulder widening, herbicide, grass seeding, guard rail. Operations such as: reclamation of existing asphalt, cold planing (milling), grading/scraping, ditching, tilling, mowing, grubbing/clearing.

10. The apparatus of claim 7, wherein the one or more construction implements comprise at least one of: earth moving equipment, materials moving equipment, materials dispensing equipment, demolitions equipment, digging equipment, excavating equipment, combinations thereof, and the like.

11. The apparatus of claim 7, wherein the processor executable instructions, that when executed by the one or more processors, cause the apparatus to determine the one or more construction tasks further cause the apparatus to:
determine an identifier associated with the construction activity; and
query a database wherein the query comprises the identifier associated with the construction activity.

12. The apparatus of claim 7, wherein the processor executable instructions, that when executed by the one or more processors, cause the apparatus to determine the one or more construction implements further cause the apparatus to:
determine an identifier associated with the construction task; and
query a database wherein the query comprises the identifier associated with the construction task; and
determine, based on the query, an association between the identifier associated with the construction task and an identifier associate with at least one construction implement of the one or more construction implements.

13. The apparatus of claim 7, wherein the processor executable instructions, that when executed by the one or more processors, cause the apparatus to determine the one or more construction implements further cause the apparatus to:
determine one or more command codes associated with at least one construction task of the one or more construction tasks; and
send at least one command code of the one or more command codes via a local, low power communications protocol, to the construction implement.

14. The apparatus of claim 7, wherein the processor executable instructions, when executed by the one or more processors, further cause the apparatus to receive, by the apparatus, a second user input wherein the second user input is configured to at least one of: cause the construction implement to cease to execute the construction task or change a parameter of the construction task.

15. A system comprising a computing device configured to:
receive, by the apparatus, one or more user inputs;
determine, based on the one or more user inputs, one or more construction activities;
determine, based on the one or more construction activities, one or more construction tasks;
determine, based on the one or more construction tasks, one or more construction implements;
send to at least one construction implement of the one or more constructions implements, a message; and
cause, based on the message, the construction implement to execute the construction task; and
the construction implement, configured to receive the message.

16. The system of claim 15, wherein the one or more programmed construction activities comprises at least one of: painting highway lines, laying asphalt, laying pavement, or grooving pavement rumble strips, raised pavement markers, shoulder widening, herbicide, grass seeding, guard rail. Operations such as: reclamation of existing asphalt, cold planing (milling), grading/scraping, ditching, tilling, mowing, grubbing/clearing.

17. The system of claim 15, wherein the one or more construction implements comprise at least one of: earth moving equipment, materials moving equipment, materials dispensing equipment, demolitions equipment, digging equipment, excavating equipment, combinations thereof, and the like.

18. The system of claim 15, wherein the computing device is configured to:
determining an identifier associated with the construction activity; and
querying a database wherein the query comprises the identifier associated with the construction activity.

19. The system of claim 15, wherein the computing device is configured to:
determine an identifier associated with the construction task; and
query a database wherein the query comprises the identifier associated with the construction task; and
determine, based on the query, an association between the identifier associated with the construction task and an identifier associate with at least one construction implement of the one or more construction implements.

20. The system of claim 15, wherein the computing device is further configured to receive, by the computing device, a second user input wherein the second user input is configured to at least one of: at least one of: cause the construction implement to cease to execute the construction task or change a parameter of the construction task.
